(19) United States
(12) Patent Application Publication
(10) Pub. No.: US 2023/0360138 A1
(43) Pub. Date: Nov. 9, 2023

(54) COMPUTER-IMPLEMENTED METHOD AND SYSTEM FOR DETERMINING A REDUCED INSURANCE PREMIUM

(71) Applicant: ONESPARK (PTY) LTD, Sandton Gauteng (ZA)

(72) Inventors: Francis Arthur GILL, Oaklands (ZA); Gregory Warren SMITH, Morningside (ZA); Josh Tana KAPLAN, Johannesburg (ZA)

(21) Appl. No.: 18/025,799

(22) PCT Filed: Sep. 15, 2021
(86) PCT No.: PCT/IB2021/058392

§ 371 Date: Mar. 10, 2023

(30) Foreign Application Priority Data
Sep. 16, 2020 (ZA) 202005734

(51) Int. Cl. G06Q 40/08

(52) U.S. Cl. CPC G06Q 40/08

(57) ABSTRACT

A system for determining a reduced insurance premium includes at least one computer and a processor. The system receives a no-lapse discount request relating to a no-lapse period implemented in respect of a policy of a client. The system receives and/or accesses policy data which includes client data and non-client data relevant to the policy. A processor calculates a premium which covers a cost of risk and a cost of expenses associated with the policy and allows for a predefined profit allocation. The processor calculates the premium based on the policy data and on the assumption that the policy will not be cancelled or allowed to lapse during the no-lapse period. The cost of expenses and the predefined profit allocation for the policy are kept unchanged relative to another policy of the same type issued by the insurer, but in respect of which a no-lapse period does not apply.

This application claims priority to South African patent application number 2020/05734, filed on 16 Sep. 2020.

### FIELD OF THE INVENTION

The invention relates to a computer-implemented method of determining a reduced insurance premium. The invention also relates to a system for determining a reduced insurance premium.

### BACKGROUND TO THE INVENTION

The insurance industry makes extensive use of cross-subsidies. One specific type of cross-subsidy centres around policy cancellations. Typically, a client with an insurance policy is required to pay a higher premium than that which is technically required to cover them in order to account for the fact that other clients are cancelling their policies. The reasoning behind this is, in simple terms, as follows: when a client cancels their policy, the insurer is losing out on premiums that they expected to earn and that would have been used to cover their expenses. As a result of losing out on these premiums, the insurer loads (increases) a client's premium in an attempt to account for this behaviour.

This means that clients may be paying significantly more each month owing to a factor that is completely outside of their control: other clients cancelling their policies. The Inventors' research and experience have revealed that the global insurance industry is plagued with these archaic cross-subsidies. In the life insurance industry, in particular, this is one of the issues that is contributing to the so-called “life insurance gap” in terms of which many individuals worldwide are not covered or not adequately covered.

There is clearly a need to eliminate or reduce these cross-subsidies and thereby enable clients to access more cover for the same premium (or the same cover for a lower premium).

However, the Inventors have found that the technical systems currently used by insurers to calculate premiums and manage policies are deficient in that they are configured to rely on cross-subsidies when automatically calculating, processing and managing policy related data. In other words, even if a client has no intention of cancelling a policy or allowing it to lapse, the computer system used by the insurer typically still calculates the premium as if there is a probability that this will happen. As such there is a technical problem with known insurance systems. Embodiments of the present invention aim to provide a technical solution capable of addressing the above issue, at least to some extent.

### SUMMARY OF THE INVENTION

In accordance with a first aspect of the invention, there is provided a computer-implemented method of determining a reduced insurance premium associated with a policy issued to a client by an insurer, the method comprising:
receiving, by at least one computer, a no-lapse discount request or a no-lapse discount confirmation originating from the client, wherein the request or confirmation relates to a no-lapse period implemented in respect of the policy;
receiving and/or accessing, by the at least one computer, policy data which includes client data and non-client data relevant to the policy; and
calculating, by a processor associated with the at least one computer, a premium which covers a cost of risk and a cost of expenses associated with the policy and allows for a predefined profit allocation, wherein the processor calculates the premium based on the policy data and on the assumption that the policy will not be cancelled or allowed to lapse during the no-lapse period, and wherein the processor is configured to calculate the premium such that the cost of expenses and the predefined profit allocation for the policy are kept unchanged relative to another policy of the same type issued by the insurer, but in respect of which a no-lapse period does not apply, thereby allowing the premium to be reduced relative to a premium associated with the other policy; and
generating, by the at least one computer, output indicative of the calculated premium and transmitting the output to a communications device associated with the client.

The no-lapse discount request or no-lapse discount confirmation may be sent to the at least one computer from the communications device of the client.

The no-lapse period may be a fixed period, e.g. a year, wherein the client has agreed not to cancel the policy or allow the policy to lapse during that period and/or has agreed to a penalty being applied in response to a cancellation or lapsing during the period.

The calculated premium may apply only to the no-lapse period. The method may include a further step of re-calculating the premium in substantially the same manner for a subsequent period if the client agrees to a further no-lapse period. This step may include updating the policy data, cost of risk, cost of expenses and/or predefined profit allocation and re-calculating the premium accordingly, i.e. using the updated policy data, cost of risk, cost of expenses and/or profit allocation (or a predefined profit allocation) and re-performing the above steps.

The method may thus be carried out iteratively in order to calculate a reduced premium or discount at every required point in time using different risk assumptions, economic assumptions, lapse rate assumptions, expense assumptions, and the like, at each of those points in time.

In some embodiments, instead of or in addition to calculating the premium, the processor may be configured to calculate a discount which can be offered to the client if the no-lapse period is applied. This discount may be taken relative to the premium associated with the other policy in respect of which a no-lapse period does not apply.

The processor may be configured to implement an algorithm which utilises factors including one or more of the client's age and time until retirement (which is a proxy for the benefit term remaining), cost of expenses, a relevant interest rate structure and lapse and claims experience, to solve for the discount that can be offered to the client during the no-lapse period assuming no cancellation or lapsing, subject to the abovementioned further constraints.

The method may include generating, by the at least one computer, output indicative of one or both of the calculated premium or the discount associated with the calculated premium, and transmitting the output to a communications device associated with the client.

The method may include receiving or determining, by the at least one computer, a cover amount associated with the policy. The cost of risk may be associated primarily or exclusively with the cover amount.

As alluded to above, the policy data may include data relating to lapse and claims experience. The processor may be configured to take into account changes, over time, in at least one client experience indicator of the insurer based on the issuing of a plurality of similar policies incorporating no-lapse periods, when calculating the premium.

The client experience indicators may include indicators of lapse experience, cancellation experience, mortality experience and/or morbidity experience. The processor may be configured to analyse past experience data relating to the client experience indicator/s and future experience data relating to expected future changes in the client experience indicator/s in order to calculate the premium. The experience data may relate to instances, levels or rates of policy lapses, policy cancellations, client mortality and/or client morbidity, or data derived therefrom.

The policy may include, but is not limited to, one or more of: life cover, disability cover, income protection and/or illness cover.

In accordance with a second aspect of the invention, there is provided a system for determining a reduced insurance premium associated with a policy issued to a client by an insurer, the system comprising at least one computer and a processor, the system being configured to:
receive a no-lapse discount request or a no-lapse discount confirmation originating from the client, wherein the request or confirmation relates to a no-lapse period implemented in respect of the policy;
receive and/or access policy data which includes client data and non-client data relevant to the policy; and
calculate, by the processor, a premium which covers a cost of risk and a cost of expenses associated with the policy and allows for a predefined profit allocation, wherein the processor calculates the premium based on the policy data and on the assumption that the policy will not be cancelled or allowed to lapse during the no-lapse period, and wherein the processor is configured to calculate the premium such that the cost of expenses and the predefined profit allocation for the policy are kept unchanged relative to another policy of the same type issued by the insurer, but in respect of which a no-lapse period does not apply, thereby allowing the premium to be reduced relative to a premium associated with the other policy; and
generate, by the at least one computer, output indicative of the calculated premium and transmit the output to a communications device associated with the client.

In accordance with a third aspect of the invention, there is provided a computer program product for determining a reduced insurance premium, the computer program product comprising at least one computer-readable storage medium having program instructions embodied therewith, the program instructions being executable by at least one computer to cause the at least one computer to carry out the method substantially as described above. The computer-readable storage medium may be a non-transitory storage medium.

### BRIEF DESCRIPTION OF THE DRAWINGS

The invention will now be further described, by way of example, with reference to the accompanying drawings. In the drawings:

FIG. 1 is a schematic illustration of an embodiment of a system according to the invention;

FIG. 2 is a flow diagram illustrating certain steps and processes in an exemplary method according to the invention; and

FIG. 3 is a block diagram of an exemplary computer system capable of executing a computer program product to provide functions and/or actions according to at least some aspects of the invention.

### DETAILED DESCRIPTION WITH REFERENCE TO THE DRAWINGS

The following description is provided as an enabling teaching of the invention, is illustrative of principles associated with the invention and is not intended to limit the scope of the invention. Changes may be made to the embodiments depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

Embodiments of the present invention provide a computerised system configured to enable clients to be “locked” into a reduced/lower insurance premium for a particular period if they believe that the policy associated with the premium will not be cancelled or allowed to lapse during that period.

Embodiments of the invention leverage advanced algorithms which address issues in the technical systems currently being used by many insurers. In particular, these advanced algorithms are configured to calculate a discount that an insurer can afford to provide for the client in each period, taking into account a number of factors, such as expenses and past and future expected experience of the life insurance book (among others). These techniques will become more readily apparent from the descriptions below.

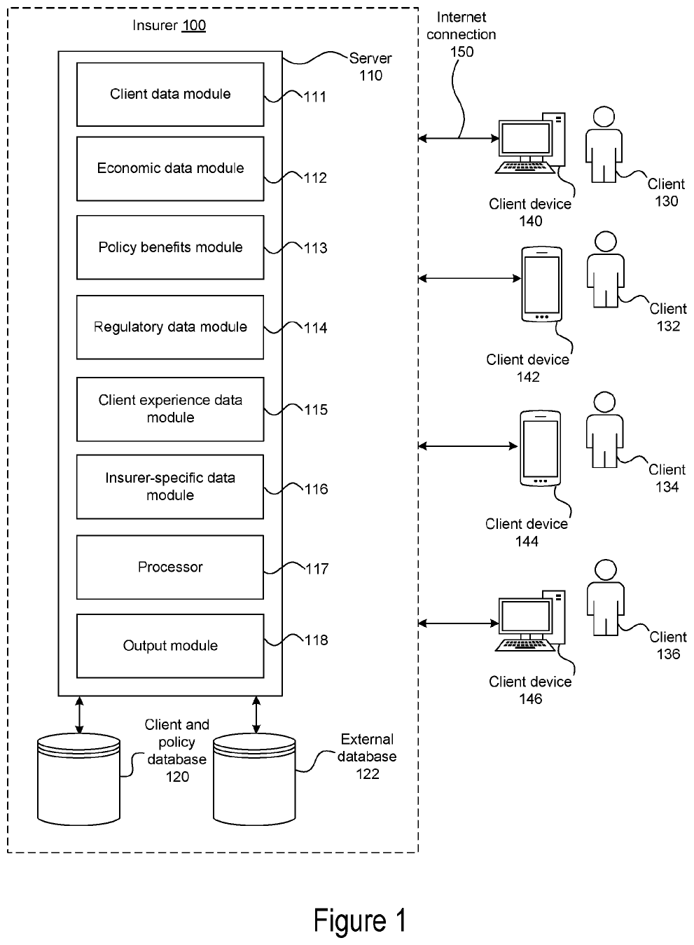

FIG. 1 shows a remotely accessible server (hereinafter “the server 110”) of an insurer 100. Insurance clients 130, 132, 134, 136 (including potential clients) are able to communicate with the insurer 100, e.g. via a suitable website or mobile application or other channels such as e-mail, in order to transmit information to and receive information from the server 110. It will be appreciated that these communications may be effected for various purposes and over any suitable communications link, such as the Internet 150.

For purposes of this specification, the clients 130, 132, 134, 136 communicate with the insurer 100 in order to obtain quotes for and acquire (enter into agreements for) insurance products/policies, such as (but not limited to) life insurance and disability insurance. The clients 130, 132, 134, 136 may also periodically communicate with the insurer 100 to update certain data relating to their policies, e.g. provide updated personal and financial information on an annual basis. The clients 130, 132, 134, 136 may also communicate with the insurer 100 for the purpose of entering into “no-lapse discount” agreements/policies, as will become apparent from the further descriptions below.

The clients 130, 132, 134, 136 may make use of any suitable communications devices in order to communicate with the insurer 100, and the client devices 140, 142, 144, 146 (mobile phones and personal computers with suitable connectivity) are shown as examples in FIG. 1. At least some aspects of the invention may also be implemented without requiring such a connection 150 between a client and the insurer 100, e.g. a client (not shown) may travel to a physical branch of the insurer 100 or meet with a financial advisor and provide the necessary input data to the insurer 100 at the branch or with the financial advisor, allowing cover, premiums and discounts to be calculated and adjusted as described in more detail below.

Typically, an insurance platform including a server like the server 110 in FIG. 1 may communicate with a large number of clients and third parties. However, for ease of reference and to illustrate aspects of the invention, an insurance policy interaction/transaction between the client 130 and the insurer 100 will be described below and reference will thus be made only to that particular client 130.

The server 110 may take various forms: it may include one or more computing devices and may be in a single location, distributed across various locations, hosted in a cloud-based environment, or combinations thereof.

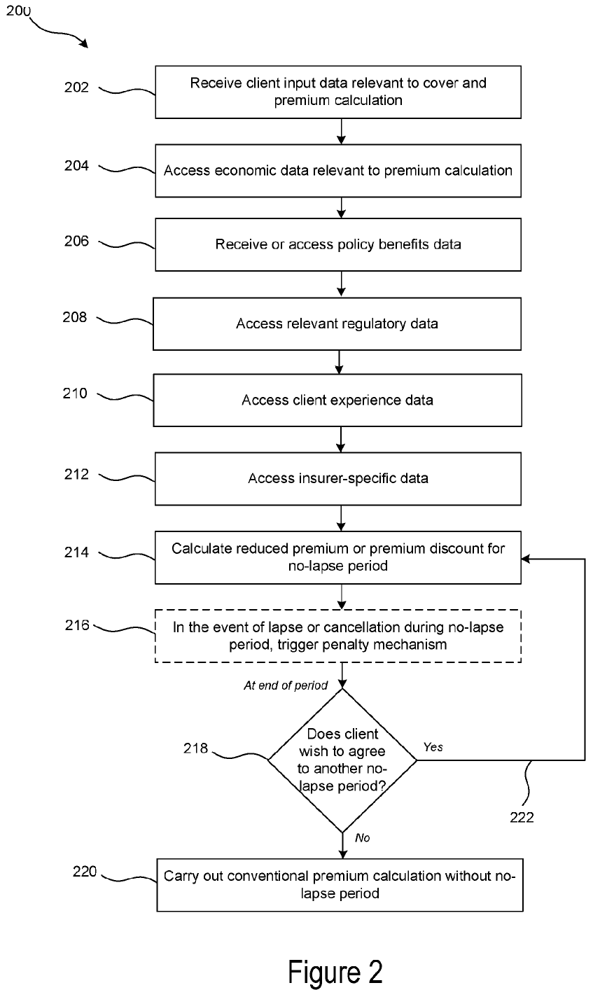

The server 110 includes a number of functional or logical components (referred to as “modules” below): a client data module 111, an economic data module 112, a policy benefits module 113, a regulatory data module 114, a client experience data module 115, an insurer-specific data module 116, a processor 117 (or multiple processors), and an output module 118. The server 110 may, in practice, include many other functional/logical components, but the above modules 111-118 are focused on herein, again, to illustrate aspects of the invention. The configuration and functionality of the modules 111-118 are described in more detail with reference to the flow diagram 200 in FIG. 2 below.

The server 110 may also typically include, or be communicatively coupled to, a number of databases such as a client and policy database 120 with data internal to the insurer (e.g. client and policy data) 100 and an external database 122 from which the insurer 100 draws external data, e.g. economic indicators, regulatory data, and the like.

The server 110 is specifically configured to implement an algorithm which calculates a premium discount (or a reduced premium that could be charged) for the client 130 at different points in time in their policy through allowing no cancellation or lapses to maintain the expense coverage and profit allowance balance (while a premium discount has been given) relative to any other life policy to which the discount does not apply. Preferably, the discount provided is independent of whether the specific client 130 had the discount in the past or what the policy composition of the client 130 was in the past.

Turning now specifically to FIG. 2, which illustrates an example methodology, at a first stage 202, the client data module 111 receives client input data. This may include data such as age, number of dependents, retirement age, occupation, gross salary, etc. This may be received from the client 130 and/or from other sources and/or the insurer 100 may already have some or all of the data in its database 120.

Then, at stage 204, the economic data module 112 receives or accesses the relevant economic data. This may include data such as a risk-free rate, relationship between asset return and risk-free rate, implied inflation over time, and the like.

At stage 206, the policy benefits module 113 receives or accesses the details of the benefits/cover required by the client 130. This includes a cover amount and may include other policy benefits. In this example, the client 130 has agreed to a “no-lapse discount”, which means that the client 130 has requested a reduced premium in exchange for agreeing not to cancel or otherwise allow the policy to lapse (or agreeing to some form of penalty in the case of a lapsing/cancellation). The “no-lapse discount” only applies to a specific, fixed period, which in this example is one year.

At stage 208, the regulatory data module 114 assesses regulatory considerations such as tax which would impact the finances of the client 130. The module 114 may also access insurance-specific regulatory data, e.g. reserving requirements.

The client experience data module 115 and the processor 117 analyse data relating to client experience at stage 210. The client experience data may include experience indicators, which may include indicators of lapse experience, cancellation experience, mortality experience and/or morbidity experience. The processor 117 may be configured to analyse past experience data relating to the client experience indicator/s and future experience data relating to expected future changes in the client experience indicator/s in order to calculate the premium.

Then, at stage 212, insurer-specific data is accessed by the insurer-specific data module 116. This may be considerations specific to the insurer 100 such as absolute profit, profit emergence, expenses incurred, and the like.

At stage 214, the processor 117 then determines the reduced premium, or a discount that can be offered to the client 130 relative to a normal premium, based on a computerised algorithm applied to the abovementioned data, and suitable output is provided to the client 130 via the output module 118.

In this example, the algorithm uses factors including the client's age and time until retirement (which is a proxy for the benefit term remaining), expenses incurred on a policy, the relevant interest rate structure and lapse, mortality and morbidity experience, to essentially solve for the discount that can be given to the client 130 for the following 12 months assuming no cancellation or lapsing, while keeping the expense coverage and profit allowance balance unchanged relative to a policy of the insurer 100 without the no-lapse discount.

This algorithm allows the insurer 100 to charge a premium that better represents a client's true risk (when viewed from a lapse point of view) for a given period (12 months in this case), which results in a lower premium. This may be advantageous to the client 130 as it results in a far more accurate and cost effective pricing methodology and alleviates or even eliminates lapse-related cross-subsidies (possibly to a greater extent over time).

Importantly, the algorithm does not rely on charging higher premiums in subsequent years (relative to a similar policy to which the discount had not applied) to fund the reduction in premium. Instead, the processor 117 is configured to calculate the discount that can be offered for the next year which allows the insurer 100 to maintain the expense coverage and profit allowance as would be experienced for a policy to which the discount does not apply.

If, for some reason, the client 130 does cancel the policy or it lapses during the one-year period, the insurer 100 may trigger a penalty agreed upon in advance with the client 130 (see stage 216 in FIG. 2). For instance, the penalty may be in the form of a cancellation fee (e.g. one month's premium) or a double premium upfront with the additional premium forfeited if the policy is cancelled/lapses. The pricing system need not necessarily be employed to determine the penalty. However, the algorithm/processor 117 may be configured to calculate discounts while ensuring that even if the client 130 cancels their policy, expense coverage and profit allocation would not be jeopardized in the current cycle (period) relative to a policy which has not selected the discount and cancels at the same point in time.

At the end of the fixed period during which the no-lapse discount applied, at stage 218, the insurer 100 may engage with the client 130 or vice versa to establish whether a further fixed period with a no-lapse discount is sought by the client 130. If not, it will be appreciated that the insurer 100 may simply carry on charging the client 130 a premium calculated in a conventional manner (stage 220) without utilising the techniques described herein. If the client 130 does wish to continue with the no-lapse discount, at stage 222, the server 110 adjusts the client information as required and then calculates a new discount/reduced premium for the subsequent fixed period, e.g. this may be done at each policy anniversary with the new discount/reduced premium then applying for the next year.

In order to illustrate certain aspects of the invention in more detail, specific, non-limiting examples are provided below, again with reference to the client 130. The South African Rand (ZAR) is used as an exemplary currency and the time value of money is ignored for the sake of simplicity, i.e. to make the examples easier to understand.

Scenario 1:

In a first scenario, it is assumed that the client 130 is aged 64 with one year until retirement. The client 130 wishes to take out a life insurance policy to provide protection against loss of income (protection for the client 130 against disability and protection for their dependants against death).

As a highly simplified example, it is assumed that the risk cost for the amount of cover required is R100 for every month the cover is provided and that expenses of R20 are incurred every month the policy is active. R110 is incurred independent of how long the policy remains active (upfront costs) and profit of R110 is allowed for. The policy is expected to remain active for 11 months.

In the above scenario, the monthly premium required to ensure that the upfront expenses are recouped and the desired profit is made over the expected duration of the policy is R140, with the calculation shown in brackets (R100+R20+R110/11+R110/11). The monthly premium using conventional techniques would thus be R140. Conventional insurers' technical systems are typically configured to automatically do the above calculation and are thus deficient in that they are not able to consider a “no-lapse discount”.

Now it is assumed that the same client 130 is given the option of a “no-lapse discount”. In other words, the client 130 is given the option to enter into an agreement where they forego the right to cancel their policy during the year (and/or are willing to pay a penalty in the event that they wish to cancel their policy during the year), the premium required to ensure that the expense coverage and predefined profit allocation is maintained would be R138.33, with the calculation shown in brackets (R100+R20+R110/12+R110/12), as the two R110 values would be divided by 12 instead of 11 as the policy is now expected to remain active for the whole year. This results in a reduced premium of R138.33 or a premium discount of R1.67 per month.

Scenario 2:

In a second scenario, it is assumed that the client 130 is aged 63 with two years until retirement (i.e. the same expected retirement age of 65). The client 130 wishes to take out a life insurance policy to provide protection against loss of income, as described above.

It is assumed that the risk cost and expenses incurred per month are the same as in Scenario 1 (R100 and R20 respectively), but that the required profit until retirement (i.e. over the 2 years) is now R160 and initial expenses incurred are R160 (incurred for a policy with a potential term of 2 years).

The calculation of the premium works similarly as in Scenario 1, but for policies that are in force at the end of the year, it is known that the next year would contribute R110 to expense and R110 to profit and there is a 8.33% chance that the policy would not remain in force until the end of the year (i.e. 91.66% chance that the policy remains in force and the insurer 100 receives that value). Again, the policy is expected to remain active for 11 months. In order to ensure that upfront expenses are recouped and profit is made, the premium would be R130.76, with the calculation shown in brackets (R100+R20+(R160−R110*91.66%)/11+(R160−R110*91.66%)/11). Conventional insurers' technical systems are typically configured to automatically do the above calculation and are thus deficient in that they are not able to consider a “no-lapse discount”.

Now it is assumed that the same client 130 is given the option of a “no-lapse discount”. In such a case, the insurer 100 has R110 profit and R110 expenses to work with (whether or not they enter into the agreement again in a year's time) with a 100% chance and the premium would be R128.33, with the calculation shown in brackets (R100+R20+(R160−R110)/12+(R160−R110)/12).

The algorithm/s employed by the server 110, e.g. by way of the processor 117, is/are configured to perform this process iteratively in order to calculate the discount at every required point in time using different risk assumptions, economic assumptions, lapse rate assumptions, expense assumptions, etc. at each of those points in time.

Additionally, it should be noted that the value of the profit allocation and expense coverage are impacted by various factors which influence premium calculation, as already mentioned above. Combining these, the algorithm solves for the premium or discount as any of the factors used to determine premiums change.

Embodiments of the invention thus provide a computerised, technical insurance product and system solution providing numerous advantages. Some of these advantages have already been identified above, and others are described below.

As explained above, the technical systems currently used by insurers to calculate premiums and manage policies are often deficient in that they are configured to rely on cross-subsidies when automatically calculating, processing and managing policy related data. This technical problem is solved by embodiments of the invention as the system described herein is specifically configured to eliminate reliance on cross-subsidies.

The research conducted by the Inventors has shown that embodiments of the invention can help clients receive a lower premium both upfront and over time and create a more sustainable life insurance industry, especially since the discount is not based on metrics or engagement outside of the life policy itself. More specifically, embodiments of the invention do not require external engagement in any program or the purchase of additional products from which profit/expense allowance is shared to make up for any shortfall on the product to which the discount is applied.

Some insurers have implemented “reduced premium” products in the market, but many of those are based on engagement in some underlying program or use of other products offered by these insurers falling outside of the ambit of the life policy. In these cases, expense coverage and profit allowance on the “reduced premium” policies may differ from the other policies of the insurer. In contrast, embodiments of the invention allow the insurer to maintain expense coverage and profit allowance relative to policies to which the discount does not apply.

The techniques employed may also ensure that an insurer does not have a preference between policies where the no-lapse discount applies and policies where it does not apply, as both policies present substantially the same economic value to the insurer. This may obviate the need to penalise clients at some later point in time in the form of higher premiums than they would have paid had they not chosen the discount in order to ensure financial viability.

Embodiments of the invention allow insurers to charge the appropriate premiums to clients based on different client needs, e.g. a particular client may know that there will not be a need to lapse/cancel within a given timeframe and that client may be charged accordingly, while a different charge is applied to others.

While the examples above have focused on the life insurance industry, it will be appreciated that embodiments of the invention may be applied broadly across the insurance industry.

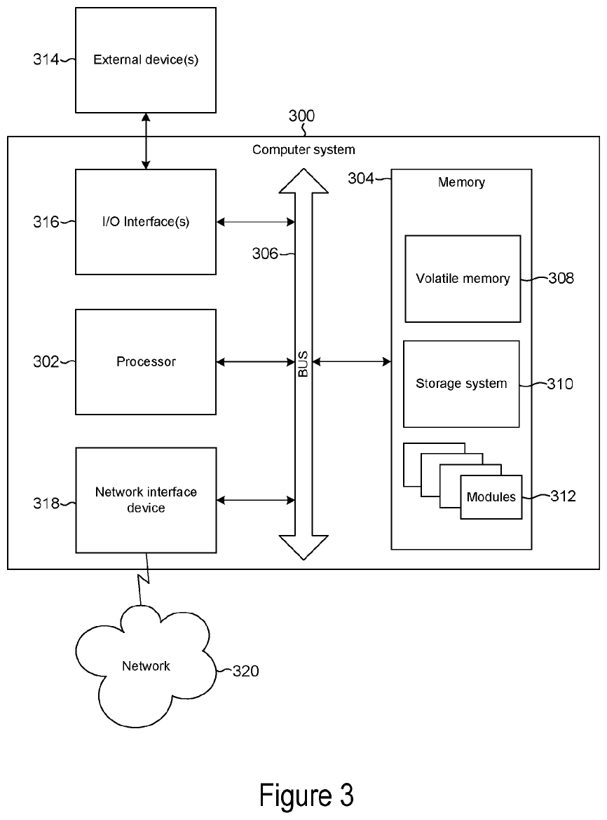

The techniques described above may be implemented in or using one or more computer systems, such as the computer system 300 shown in FIG. 3. The computer system 300 may be or include any suitable computer or server. The server 110 may include such a computer system 300. The computer system 300 may be implemented in distributed cloud computing environments where tasks are performed by remote processing devices that are linked through a communications network. In a distributed cloud computing environment, program modules executed by the computer system 300 may be located both locally and remotely.

In the example shown in FIG. 3, the computer system 300 has features of a general-purpose computer. These components may include, but are not limited to, at least one processor 302, a memory 304 and a bus 306 that couples various components of the system 300 including the memory 304 to the processor 302. The bus 306 may have any suitable type of bus structure. The computer system 300 may include one or more different types of readable media, such as removable and non-removable media and volatile and non-volatile media.

The memory 304 may thus include volatile memory 308 (e.g. random access memory (RAM) and/or cache memory) and may further include other storage media such as a storage system 310 configured for reading from and writing to a non-removable, non-volatile media such as a hard drive. It will be understood that the computer system 300 may also include or be coupled to a magnetic disk drive and/or an optical disk drive (not shown), and/or any other suitable type of drive, for reading from or writing to suitable non-volatile media. These may be connected to the bus 306 by one or more data media interfaces.

The memory 304 may be configured to store program modules 312. The modules 312 may include, for instance, an operating system, one or more application programs, other program modules, and program data, each of which may include an implementation of a networking environment. The components of the computer system 300 may be implemented as modules 312 which generally carry out functions and/or methodologies of embodiments of the invention as described herein. It will be appreciated that embodiments of the invention may include or be implemented by a plurality of the computer systems 300, which may be communicatively coupled to each other.

The computer system 300 may operatively be communicatively coupled to at least one external device 314. For instance, the computer system 300 may communicate with external devices 314 in the form of a modem, keyboard and display. These communications may be effected via suitable Input/Output (I/O) interfaces 316.

The computer system 300 may also be configured to communicate with at least one network 320 (e.g. the Internet or a local area network) via a network interface device 318/network adapter. The network interface device 318 may communicate with the other elements of the computer system 310, as described above, via the bus 306.

The components shown in and described with reference to FIG. 3 are examples only and it will be understood that other components may be used as alternatives to or in conjunction with those shown.

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions. Instructions may be provided to a processor of any suitable computer or other apparatus such that the instructions, which may execute via the processor of the computer or other apparatus, establish or generate means for implementing the functions or actions identified in the figures.

1. A computer-implemented method of determining a reduced insurance premium associated with a policy issued to a client by an insurer, the method comprising:
receiving, by at least one computer, a no-lapse discount request or a no-lapse discount confirmation originating from the client, wherein the request or confirmation relates to a no-lapse period implemented in respect of the policy;
receiving and/or accessing, by the at least one computer, policy data which includes client data and non-client data relevant to the policy; and
calculating, by a processor associated with the at least one computer, a premium which covers a cost of risk and a cost of expenses associated with the policy and allows for a predefined profit allocation, wherein the processor calculates the premium based on the policy data and on the assumption that the policy will not be cancelled or allowed to lapse during the no-lapse period, and wherein the processor is configured to calculate the premium such that the cost of expenses and the predefined profit allocation for the policy are kept unchanged relative to another policy of the same type issued by the insurer, but in respect of which a no-lapse period does not apply, thereby allowing the calculated premium to be reduced relative to a premium associated with the other policy; and
generating, by the at least one computer, output indicative of the calculated premium and transmitting the output to a communications device associated with the client.

2. The method according to claim 1, wherein the no-lapse period is a fixed period in respect of which the client has agreed not to cancel the policy or allow the policy to lapse, and wherein the client has agreed to a penalty being applied in response to a cancellation or lapsing during the no-lapse period.

3. The method according to claim 2, wherein the calculated premium applies only to the no-lapse period, the method further including re-calculating, by the processor, the premium for a subsequent period if the client agrees to a further no-lapse period.

4. The method according to claim 3, wherein re-calculating the premium includes updating, by the at least one computer, at least the policy data, the cost of risk and the cost of expenses, and calculating, by the processor, a premium which covers the updated cost of risk and the updated cost of expenses and allows for a predefined profit allocation, wherein the processor calculates the premium based on the updated policy data and on the assumption that the policy will not be cancelled or allowed to lapse during the no-lapse period.

5. The method according to claim 1, which includes calculating, by the processor, a discount which can be offered to the client if the no-lapse period is applied, wherein the discount is taken relative to the premium associated with the other policy in respect of which a no-lapse period does not apply, the method including generating, by the at least one computer, output indicative of the discount associated with the calculated premium, and transmitting the output to the communications device associated with the client.

6. The method according to claim 5, wherein the processor is further configured to implement an algorithm which utilises factors including one or more of an age of the client, time until retirement of the client, cost of expenses, interest rate structure and lapse and claims experience, to solve for the discount that can be offered to the client during the no-lapse period assuming no cancellation or lapsing.

7. The method according to claim 1, wherein the policy data includes data relating to lapse and claims experience, the processor being configured to take into account changes, over time, in at least one client experience indicator of the insurer based on the issuing of a plurality of similar policies incorporating no-lapse periods, when calculating the premium.

8. The method according to claim 7, wherein the at least one client experience indicator includes indicators of lapse experience, cancellation experience, mortality experience and/or morbidity experience, the processor being configured to analyse past experience data relating to the client experience indicator/s and future experience data relating to expected future changes in the client experience indicator/s in order to calculate the premium.

9. A system for determining a reduced insurance premium associated with a policy issued to a client by an insurer, the system comprising at least one computer and a processor, the system being configured to:
receive a no-lapse discount request or a no-lapse discount confirmation originating from the client, wherein the request or confirmation relates to a no-lapse period implemented in respect of the policy;
receive and/or access policy data which includes client data and non-client data relevant to the policy; and
calculate, by the processor, a premium which covers a cost of risk and a cost of expenses associated with the policy and allows for a predefined profit allocation, wherein the processor calculates the premium based on the policy data and on the assumption that the policy will not be cancelled or allowed to lapse during the no-lapse period, and wherein the processor is configured to calculate the premium such that the cost of expenses and the predefined profit allocation for the policy are kept unchanged relative to another policy of the same type issued by the insurer, but in respect of which a no-lapse period does not apply, thereby allowing the premium to be reduced relative to a premium associated with the other policy; and
generate, by the at least one computer, output indicative of the calculated premium and transmit the output to a communications device associated with the client.

10. The system according to claim 9, wherein the no-lapse period is a fixed period in respect of which the client has agreed not to cancel the policy or allow the policy to lapse, and wherein the client has agreed to a penalty being applied in response to a cancellation or lapsing during the no-lapse period.

11. The system according to claim 10, wherein the calculated premium applies only to the no-lapse period, the system being configured to re-calculate, by the processor, the premium for a subsequent period if the client agrees to a further no-lapse period.

12. The system according to claim 11, wherein re-calculating the premium includes updating at least the policy data, the cost of risk and the cost of expenses, and calculating, by the processor, a premium which covers the updated cost of risk and the updated cost of expenses and allows for a predefined profit allocation, wherein the processor calculates the premium based on the updated policy data and on the assumption that the policy will not be cancelled or allowed to lapse during the no-lapse period.

13. The system according to claim 9, wherein the processor is configured to calculate a discount which can be offered to the client if the no-lapse period is applied, wherein the discount is taken relative to the premium associated with the other policy in respect of which a no-lapse period does not apply, the system further being configured to generate, by the at least one computer, output indicative of the discount associated with the calculated premium, and to transmit the output to the communications device associated with the client.

14. The system according to claim 13, wherein the processor is configured to implement an algorithm which utilises factors including one or more of an age of the client, time until retirement of the client, cost of expenses, interest rate structure and lapse and claims experience, to solve for the discount that can be offered to the client during the no-lapse period assuming no cancellation or lapsing.

15. The system according to claim 9, wherein the policy data includes data relating to lapse and claims experience, the processor being configured to take into account changes, over time, in at least one client experience indicator of the insurer based on the issuing of a plurality of similar policies incorporating no-lapse periods, when calculating the premium.

16. The system according to claim 15, wherein the at least one client experience indicator includes indicators of lapse experience, cancellation experience, mortality experience and/or morbidity experience, the processor being configured to analyse past experience data relating to the client experience indicator/s and future experience data relating to expected future changes in the client experience indicator/s in order to calculate the premium.
